(19) United States
(12) Patent Application Publication
(10) Pub. No.: US 2013/0155255 A1
(43) Pub. Date: Jun. 20, 2013

(54) ELECTRONIC DEVICE AND METHOD FOR CONTROLLING CAMERA OF THE ELECTRONIC DEVICE ACCORDING TO GESTURES

(71) Applicants: Fu Tai Hua Industry (Shenzhen) Co., Ltd., Shenzhen (CN); HON HAI PRECISION INDUSTRY CO., LTD., New Taipei (TW)

(72) Inventor: QI-LONG YU, Shenzhen (CN)

(73) Assignees: HON HAI PRECISION INDUSTRY CO., LTD., New Taipei (TW); FU TAI HUA INDUSTRY (SHENZHEN) CO., LTD., Shenzhen (CN)

(21) Appl. No.: 13/688,245

(22) Filed: Nov. 29, 2012

(30) Foreign Application Priority Data
Dec. 17, 2011 (CN) 201110423678.7

(51) Int. Cl. H04N 5/232; H04N 5/33

(52) U.S. Cl. CPC H04N 5/23203; H04N 5/33
USPC 348/164; 348/211.99

(57) ABSTRACT

A method for controlling a camera according to gestures for an electronic device is provided. The electronic device includes an optical camera, an infrared camera and a storage unit. The storage unit stores a table recording relationships between gestures for controlling camera and photographic commands. The method includes the following steps: generating a signal for activating a composite mode of the electronic device; controlling the optical camera to record real-time videos, and controlling the infrared camera to record real-time color temperature photographs; determining whether the gesture of the user is a gesture for controlling camera according to the video and the corresponding color temperature photograph; controlling the electronic device to enter a photographic mode when the gesture of the user is a gesture for controlling photography; and determining a camera command and executing the determined photography command. An electronic device using the method is also provided.

### BACKGROUND

1. Technical Field

The present disclosure relates to an electronic device having a camera and a method for controlling the camera according to the gestures of a user.

2. Description of Related Art

Electronic devices with cameras, such as mobile phones, digital photo frames, electronic readers (e-reader), are popular. Users can take photographs anytime and anywhere they want. However, when the user is alone or all the users want to be taken in a group photo, the single user or the group users usually need(s) to ask an outsider for help to take the photo. Some electronic devices can automatically take the photos for the user when they are pre-set in advance, and leave the user a predetermined time period for preparing postures. Under this automatic camera-activated mode, the user assigned to pre-set the photography details should prepare his posture in the predetermined short time period. Furthermore, in this case, the users usually don't know how long the predetermined short time period is, which may cause the photos taken in unsatisfactory positions.

Therefore, what is needed is an electronic device and a method to alleviate the limitations described above.

### BRIEF DESCRIPTION OF THE DRAWINGS

The components in the drawings are not necessarily drawn to scale, the emphasis instead being placed upon clearly illustrating the principles of the present disclosure. Moreover, in the drawings, like reference numerals designate corresponding sections throughout the several views.

FIG. 1 is a block diagram of an electronic device in accordance with an exemplary embodiment.

FIG. 2 is a table recording the mapping relationship between a number of camera control gestures and a number of camera commands of the electronic device of FIG. 1.

FIG. 3 is a schematic figure showing the color temperature of a human hand.

FIG. 4 is a flowchart of a method for controlling a camera according to a user's gestures for electronic devices, such as the one of FIG. 1, in accordance with the exemplary embodiments.

### DETAILED DESCRIPTION

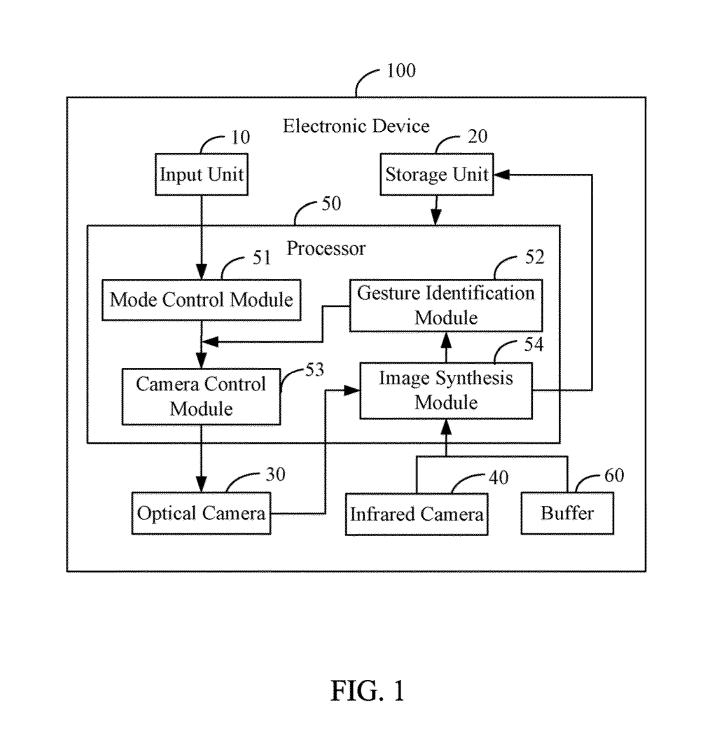

FIG. 1 is an exemplary embodiment of a block diagram of an electronic device 100. The electronic device 100 provides the user a convenient way for controlling the photography function of the electronic device 100 by using different gestures. The electronic device 100 is a mobile terminal with an optical camera 30, such as a mobile phone, or a digital camera. In alternative embodiments, the electronic device 100 can be other electronic devices with optical cameras, such as an electronic reader, a tablet, a digital phone frame, for example.

The electronic device 100 includes an input unit 10, a storage unit 20, an optical camera 30, an infrared camera 40, and a processor 50. The input unit 10 is configured for generating a signal for activating a composite mode or a camera-activated mode for the electronic device 100 in response to an input from a user, and transmitting the signal to the processor 50. The storage unit 20 stores electronic files such as photos taken by the electronic device 100, audio files, or video files.

The processor 50 includes a mode control module 51, a gesture identification module 52, a camera control module 53, and an image synthesis module 54.

The mode control module 51 is configured for controlling the electronic device 100 to enter a composite mode or a camera-activated mode, when the signal for activating a composite mode for the electronic device 100 generated by the input unit 10 is received.

The camera control module 53 is configured for controlling the optical camera 30 to capture a photo, or controlling the infrared camera 40 to record a video of a gesture of a user according to the current mode of the electronic device 100.

The optical camera 30 is used for automatically photography the real-time videos when the electronic device 100 is in the composite mode, and for taking photos or photography videos according to the gestures of the user. The camera control module 53 further stores the photos and videos captured by the optical camera 30 in the storage unit 20.

The infrared camera 40 is configured for capturing the real-time color temperature images of the gesture of the user when the electronic device 100 is in the composite mode. In the embodiment, the infrared camera 40 is an infrared thermal imaging camera. When a human is in front of the infrared camera 40, the color temperature images of the human body captured by the infrared camera 40 have a number of brightness levels and a number of color levels. This is because the temperature of the human body is different from the temperature of the environment around him/her, as well some of the parts are exposed from clothes, and the impact of the human blood circulation has different brightness levels. For example, the color temperature images of the parts of the human body that are exposed from clothes such as the head, a hand, for example, have distinct brightness and color differences compared with the other parts of the human body. Furthermore, the shape of the head is quite different from the shape of the hand, thus, it is easier to distinguish the head from the hand of the human

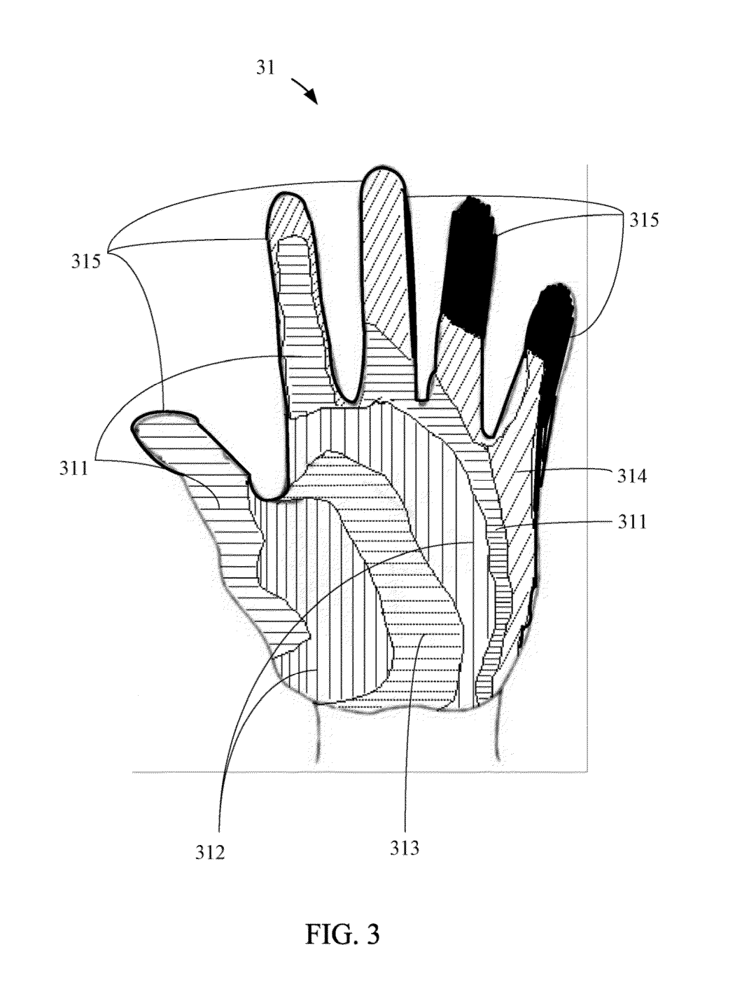

FIG. 3 is a schematic view showing the color temperature FIG. 31 of a human hand. The region 311 is infilled with horizontal solid lines is crimson, the region 312 infilled with vertical solid lines is pink, the region 313 infilled with horizontal dotted lines is blue, the region 314 infilled with oblique dotted lines is yellow, and the region 315 infilled with black thick lines is green.

The image synthesis module 54 is configured for synthesizing a composite image by using the real-time video photographed by the optical camera 30 and the color temperature image of the gesture of the user captured by the infrared camera 40. In the embodiment, the shape images of a same part captured by the optical camera 30 and the infrared camera 40 at a substantially same time, have minor differences because of the fixing positions and shooting angles of the optical camera 30 and the infrared camera 40 are different. The image synthesis module 54 further calibrates the images according to the fixing positions and shooting angles of the optical camera 30 and the infrared camera 40, and then synthesizes the composite image by using the calibrated images. In another embodiment, the image synthesis module 54 is configured for synthesizing an image by using the real-time video photographed by the optical camera 30, and imaging another image by using the color temperature image of the gesture of the user captured by the infrared camera 40. That is, the image synthesis module 54 synthesizes different images according to the real-time video and the color temperature image of the gesture of the user separately.

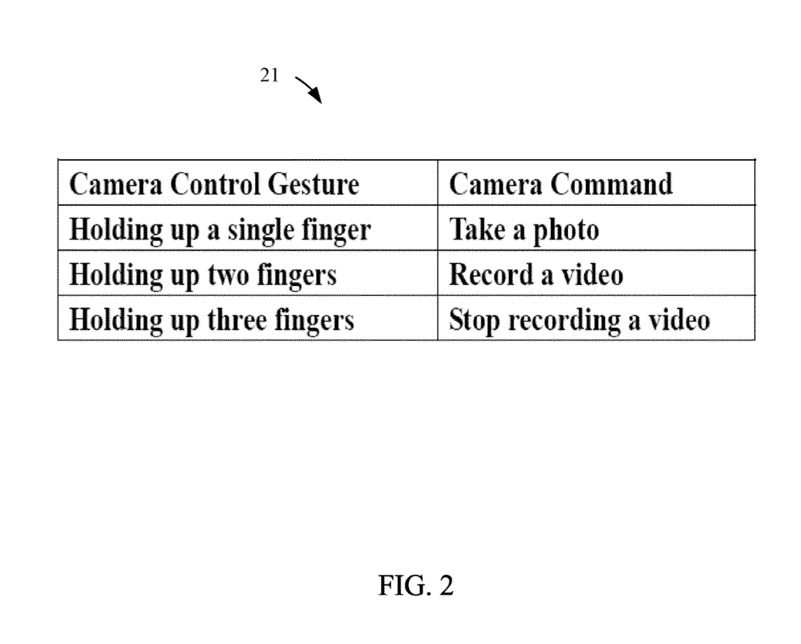

FIG. 2 shows that the storage unit 20 stores a table 21 recording the mapping relationship between a number of camera control gestures and a number of camera commands used for the optical camera 30. In the embodiment, if the camera control gesture of the user is holding up a single finger, the associated camera command is to take a photo. If the camera control gesture of the user is holding up two fingers, the associated camera command is record a video, and if the camera control gesture of the user is holding up three fingers, the associated camera command is to stop recording a video. It is to be understood, the number of finger(s) used for the camera control gestures can vary according to need.

The gesture identification module 52 is configured for identifying whether the gesture of the user is a camera control gesture according to the composite image synthesized by the image synthesis module 54. The gesture identification module 54 further transmits the identified results to the mode control module 51 and the camera control module 53. In the embodiment, the gesture identification module 53 identifies the hand image from the composite image, and determines whether the gesture is a camera control gesture according to the hand image and the table 21. The identification accuracy is improved because of the composite image are synthesized using a color temperature image of the gesture of the user. In another embodiment, the gesture identification module 52 identifies the gesture according to the images synthesized by the image synthesis module 54 at a same time, one image is synthesized by using the real-time video photographed by the optical camera 30 and the other image is synthesized by using the color temperature image of the gesture of the user captured by the infrared camera 40. Then, the gesture identification module 52 compares and analyzes the gesture according to the images imaged by the image synthesis module 54, and finally determines whether the gesture is a camera control gesture.

The mode control module 51 further controls the electronic device 100 to quit the composite mode and enter the camera-activated mode, when the gesture identification module 52 determines the gesture of the user is a camera control gesture.

The camera control module 53 is further configured for determining a command according to the camera control gesture identified by the gesture identification module 52 and the table 21 stored in the storage unit 20, and for controlling the optical camera 30 of the electronic device 100 to execute the command. In the embodiment, if the gesture identification module 52 identifies the gesture of the user is holding up a single finger, the camera control module 53 determines the associated camera command is taking a photo according to the table 21, and controls the optical camera 30 to take a photo. If the gesture identification module 52 identifies the gesture of the user is putting up two fingers, the camera control module 53 determines the associated camera command is recording a video, and controls the optical camera 30 to record a video. If the gesture identification module 52 identifies the gesture of the user is holding up three fingers, the camera control module 53 determines the associated camera command is to stop recording a video, and controls the optical camera 30 to stop recording a video.

In the embodiment, the electronic device 100 further includes a buffer 60 configured for temperately storing the composite images synthesized by the image synthesis module 54 and the images imaged by the image synthesis module 54.

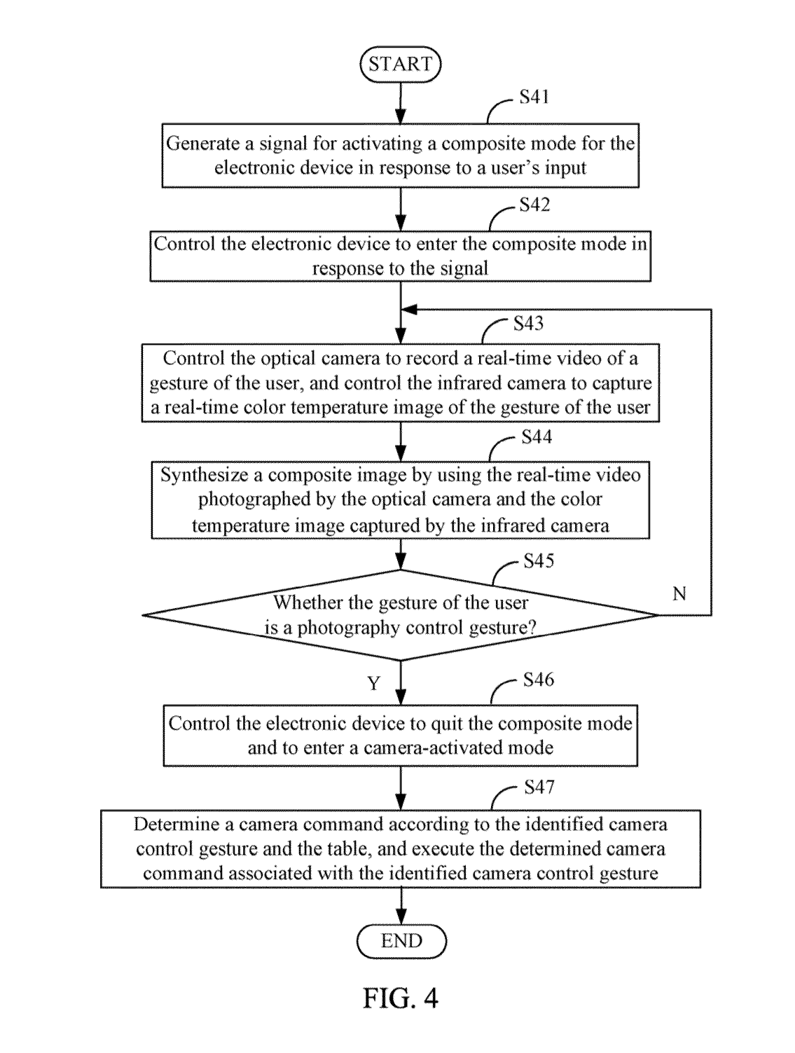

FIG. 4 shows a flowchart of a method for controlling a camera according to a user's gestures of the electronic device 100 of FIG. 1. The electronic device 100 includes an optical camera, an infrared camera, and a storage unit. The storage unit stores a table 21 recording the mapping relationship between a number of camera control gestures and a number of camera commands The method includes the following steps, each of which is related to the various components contained in the electronic device 100.

In step S41, the input unit 10 generates a signal for activating a composite mode for the electronic device 100 in response to a user's input.

In step S42, the mode control module 51 controls the electronic device 100 to enter the composite mode in response to the signal.

In step S43, the camera control module 53 controls the optical camera 30 to record a real-time video of a gesture of the user, and controls the infrared camera 40 to capture a real-time color temperature image of the gesture of the user.

In step S44, the image synthesis module 54 synthesizes a composite image by using the real-time video photographed by the optical camera 30 and the color temperature image captured by the infrared camera 40. The real-time video and the color temperature image are captured at a substantially same time. In another embodiment, the image synthesis module 54 is configured for synthesizing an image by using the real-time video photographed by the optical camera 30, and imaging another image by using the color temperature image captured by the infrared camera 40.

In step S45, the gesture identification module 52 identifies whether the gesture of the user is a camera control gesture by analyzing the composite image synthesized by the image synthesis module 54. If yes, the process goes to step S46, otherwise, the process goes back to step S43. The gesture identification module 52 further transmits the identified results to the mode control module 51 and the camera control module 53.

In step S46, the mode control module 51 controls the electronic device 100 to quit the composite mode and to enter a camera-activated mode.

In step S47, the camera control module 53 determines a camera command according to the identified camera control gesture and the table 21 stored in the storage unit 20, and executes the determined camera command associated with the identified camera control gesture.

With such a configuration, the user can control the electronic device 100 to enter a composite mode, and then the electronic device 100 can identify whether the gesture of the user is a camera control gesture according to the real-time videos shoot by the optical camera 30 and the real-time color temperature images captured by the infrared camera 40. The user can conveniently control the optical camera 30 to take a photo or record a video for him via the predetermined gestures.

Although the present disclosure has been specifically described on the basis of the embodiments thereof, the disclosure is not to be construed as being limited thereto. Various changes or modifications may be made to the embodiments without departing from the scope and spirit of the disclosure.

What is claimed is:

1. A method for controlling camera according to gestures, the method used for an electronic device having an optical camera, an infrared camera, and a storage unit storing a table recording the mapping relationship between a plurality of camera control gestures and a plurality of camera control commands, the method comprising:
generating a signal for activating a composite mode for the electronic device in response to a user's input;
controlling the electronic device to enter the composite mode in response to the signal;
controlling the optical camera to record a real-time video of a gesture of a user, and controlling the infrared camera to capture a real-time color temperature image of the gesture of the user;
identifying whether the gesture of the user is a camera control gesture by analyzing the real-time video and the color temperature image of the gesture of the user;
controlling the electronic device to quit the composite mode and to enter a camera-activated mode, if the gesture of the user is a camera control gesture; and
determining a camera control command according to the identified camera control gesture and the table, and executing the camera control command associated with the identified camera control gesture.

2. The method as described in claim 1, wherein the step of “identifying whether the gesture of the user is a camera control gesture” comprises:
synthesizing a composite image by using the real-time video photographed by the optical camera and the color temperature image captured by the infrared camera, the real-time video and the color temperature image being captured at a substantially same time; and
identifying whether the gesture of the user is a camera control gesture according to the composite image.

3. The method as described in claim 2, wherein the step “identifying whether the gesture of the user is a camera control gesture according to the composite image” comprises:
identifying a hand image in the composite image; and
identifying whether the gesture of the user is a camera control gesture according to the identified hand image and the table.

4. The method as described in claim 1, wherein the camera control gesture is selected from the group consisting of: putting up a single finger, putting up two fingers, and putting up three fingers.

5. The method as described in claim 4, wherein if the camera control gesture is holding up a single finger, the associated camera control command is to take a photo, if the camera control gesture is holding up two fingers, the associated camera control command is to record a video, and if the camera control gesture is holding up three fingers, the associated camera control command is to stop recording a video.

6. The method as described in claim 1, wherein the electronic device is a mobile phone or a digital camera.

7. An electronic device comprising:
a storage unit, storing table recording the mapping relationship between a plurality of camera control gestures and a plurality of camera control commands;
an input unit, configured for generating a signal for activating a composite mode for the electronic device in response to a user's input;
an optical camera;
an infrared camera; and
a processor comprising:
a mode control module, configured for controlling the electronic device to enter the composite mode in response to the signal for activating a composite mode, and controlling the electronic device to quit the composite mode and to enter a camera control mode if the gesture of the user is a camera control gesture;
a camera control module, configured for controlling the optical camera to photograph a real-time video of a gesture of a user, and controlling the infrared camera to take a real-time color temperature image of the gesture of the user, when the electronic device is in the composite mode; and
a gesture identification module, configured for identifying whether the gesture of the user is a cameral control gesture by analyzing the real-time video and the real-time color temperature image, the camera control module, configured for determining a camera control command according to the identified camera control gesture and the table, and executing the determined camera control command

8. The electronic device as described in claim 7, further comprising an image synthesis module configured for synthesizing a composite image by using the real-time video photographed by the optical camera and the color temperature image captured by the infrared camera, wherein the real-time video and the color temperature image are captured at a substantially same time.

9. The electronic device as described in claim 8, wherein the gesture identification module is further configured for identifying a hand image in the composite image, and determining whether the gesture of the user is a camera control gesture according to the identified hand image.

10. The electronic device as described in claim 7, wherein camera control gesture is selected from the group consisting of: holding up a single finger, holding up two fingers, and holding up three fingers.

11. The electronic device as described in claim 10, wherein if the camera control gesture is holding up a single finger, the associated camera command is to take a photo, if the camera control gesture is holding up two fingers, the associated camera command is to record a video, and if the camera control gesture is holding up three fingers, the associated camera command is to stop recording a video.

12. The electronic device as described in claim 7, wherein the infrared camera is an infrared thermal imaging camera.

13. The electronic device as described in claim 7, wherein the electronic device is a mobile phone or a digital camera.
